(19) United States
(12) Patent Application Publication
(10) Pub. No.: US 2014/0028017 A1
(43) Pub. Date: Jan. 30, 2014

(54) JUNCTION DEVICE FOR DUCTS AND PIPELINES

(71) Applicants: Anna STIATTI, Milano (IT); Alberto STIATTI, Milano (IT); Matteo Maria STIATTI, Milano (IT)

(72) Inventors: Anna STIATTI, Milano (IT); Alberto STIATTI, Milano (IT); Matteo Maria STIATTI, Milano (IT)

(21) Appl. No.: 13/945,254

(22) Filed: Jul. 18, 2013

(30) Foreign Application Priority Data
Jul. 30, 2012 (IT) MI2012U 000285

(51) Int. Cl. F16L 15/08

(52) U.S. Cl. CPC F16L 15/08
USPC 285/119

(57) ABSTRACT

A junction device for ducts and pipelines is described, made up of an internally hollow main body manufactured with a plastic material obtained through molding. The main body being provided with connection means configured for connecting and for sealingly fixing the junction device to one or more pipelines and/or to one or more apparatuses to which such pipelines must be connected. The junction device comprises at least one plate in plastic material, molded in a single piece with the main body. On at least one of the two opposite surfaces of such a plate being imprinted information relative to the junction device, like for example one or more identifier codes or barcodes, a description of the junction device itself, brands and/or logos of any kind.

### CROSS-REFERENCE TO RELATED APPLICATION

This application claims the benefit of Italian Patent Application No. M12012U 00285, filed Jul. 30, 2012, the contents of which are incorporated herein by reference.

### FIELD OF THE INVENTION

The present invention refers to a junction device for ducts and pipelines, in particular a junction device manufactured with a plastic material.

### BACKGROUND OF THE INVENTION

The use of junction devices is known for joining pipelines and/or for the connection of one or more pipelines to various apparatuses. The junction devices are generally configured in a way such as to allow fluid to flow inside them. Some junction devices can, on the other hand, be configured for intercepting the fluid transiting inside them.

A generic junction device is usually made up of a hollow shaped body, which is suitably shaped according to the type of use. Among known junction devices there are indeed, to mention some, sleeves, nipples, reducers, Oldham couplings, knee joints, T-joints, X-joints and Y-joints.

Junction devices are thus provided with means for connecting to the pipelines and/or to the apparatuses to which such pipelines must be connected. There are therefore junction devices that are threaded, internally or externally, and thus suitable for connecting with pipelines and/or apparatuses provided with corresponding threadings or with respective lock nuts. There are also junction devices that are provided with so called quick coupling means, and therefore that are suitable for the connection to pipelines and/or apparatuses without the help of specific tools.

Irrespective of the type, connection means of junction devices must be capable of ensuring the seal of the devices themselves. When necessary, the seal can be increased thanks to special gaskets. The junction devices can be manufactured with both metal materials (cast iron, steel, galvanised sheet, etc.), and with plastic materials.

Irrespective of the material with which they are manufactured and due to their multiple embodiments, the various junction devices are normally identified and classified thanks to special identifier codes or barcodes. A typical drawback that occurs in storage warehouses and points of sales is however related to the difficulty in reading these identifier codes or barcodes when applied onto the junction devices. Indeed, the identifier codes or barcodes are normally applied on the junction devices in the form of self-adhesive labels. Since the junction devices have a complex and rounded shape, however, the labels provided with identifier codes or barcodes are often illegible.

Another drawback is related to the fact that the labels provided with identifier codes or barcodes can become detached from the junction device over time, or due to handling and to the movements the junction device itself can undergo. The junction devices can thus reach the cash register of the point of sales without their identifier code or barcode, thus being inconvenient both for the customers, and for the sales staff.

### SUMMARY OF THE INVENTION

The general purpose of the present invention is therefore that of making a junction device for ducts and pipelines, in particular a junction device manufactured with a plastic material, which is capable of solving the aforementioned drawbacks mentioned in the prior art in an extremely simple, cost-effective and particularly functional manner.

In detail, one purpose of the present invention is that of making a junction device for ducts and pipelines, in particular a junction device manufactured with a plastic material, which can always be perfectly identified, thanks to its own identifier code or barcode, up to the moment in which it is purchased by the end user and possibly longer.

Another purpose of the invention is that of making a junction device for ducts and pipelines that is provided from the start, that is to say from its manufacturing step, with both its identifier code or barcode, and with possible writings or logos of any kind, like for example the brand of the manufacturer and/or that of the user.

A further purpose of the invention is that of making a junction device for ducts and pipelines that can be manufactured in a simple and completely automated manner.

These purposes according to the present invention are achieved by making a junction device for ducts and pipelines, in particular a junction device manufactured with a plastic material, as outlined in claim 1.

Further characteristics of the invention are highlighted by the dependent claims, which are an integrating part of the present description.

### BRIEF DESCRIPTION OF THE DRAWINGS

The characteristics and the advantages of a junction device for ducts and pipelines according to the present invention shall become clearer from the following description, given as an example and not for limiting purposes, with reference to the attached schematic drawings, in which:

FIG. 1A is a side elevation view of a first embodiment of the junction device for ducts and pipelines according to the present invention, manufactured in the form of a quick coupling means;

FIG. 1B is a perspective view of the junction device of FIG. 1A;

FIG. 2A is a side elevation view of a second embodiment of the junction device for ducts and pipelines according to the present invention, manufactured in the form of a nipple with a constant inner diameter;

FIG. 2B is a perspective view of the junction device of FIG. 2A;

FIG. 3A is a side elevation view of a third embodiment of the junction device for ducts and pipelines according to the present invention, that is manufactured in the form of a nipple with a variable inner diameter;

FIG. 3B is a perspective view of the junction device of FIG. 3A;

FIG. 4A is a side elevation view of a fourth embodiment of the junction device for ducts and pipelines according to the present invention, that is manufactured in the firm of a reducer joint;

FIG. 4B is a perspective view of the junction device of FIG. 4A;

FIG. 5A is a side elevation view of a fifth embodiment of the junction device for ducts and pipelines according to the present invention, manufactured in the form of a sleeve with a constant inner diameter;

FIG. 5B is a perspective view of the junction device of FIG. 5A;

FIG. 6A is a side elevation view of a sixth embodiment of the junction device for ducts and pipelines according to the present invention, manufactured in the form of a sleeve with a variable inner diameter;

FIG. 6B is a perspective view of the junction device of FIG. 6A;

FIG. 7A is a side elevation view of a seventh embodiment of the junction device for ducts and pipelines according to the present invention, manufactured in the form of a knee joint;

FIG. 7B is a perspective view of the junction device of FIG. 7A;

FIG. 8A is a side elevation view of an eighth embodiment of the junction device for ducts and pipelines according to the present invention, manufactured in the form of a T-joint; and

FIG. 8B is a perspective view of the junction device of FIG. 8A.

### DETAILED DESCRIPTION OF THE DRAWINGS

With reference to the figures, these show some preferred embodiments of the junction device for ducts and pipelines according to the present invention, wholly indicated throughout with reference numeral.

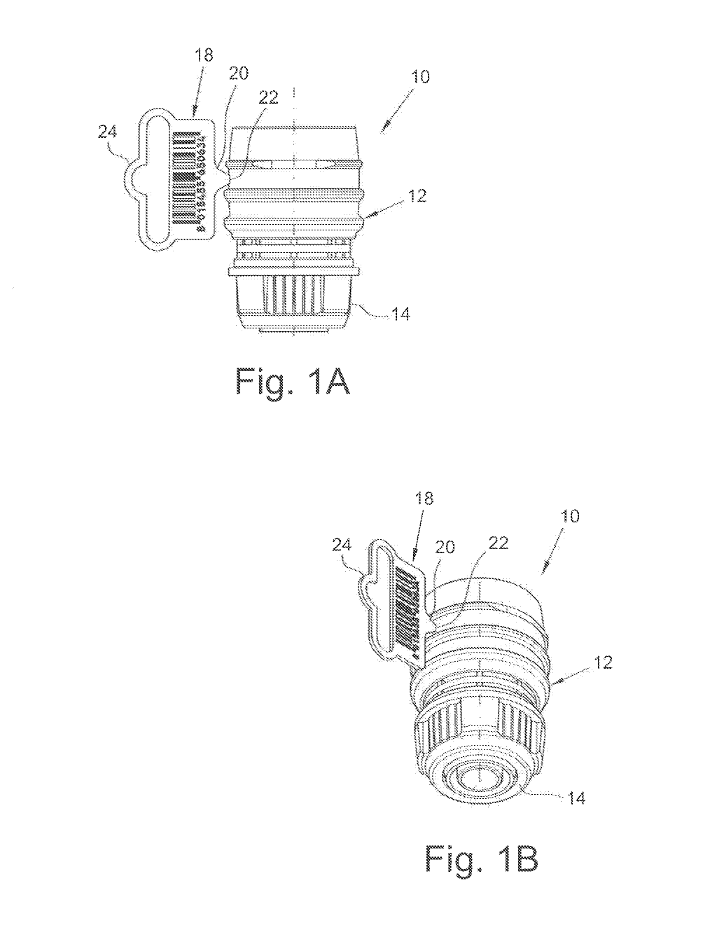

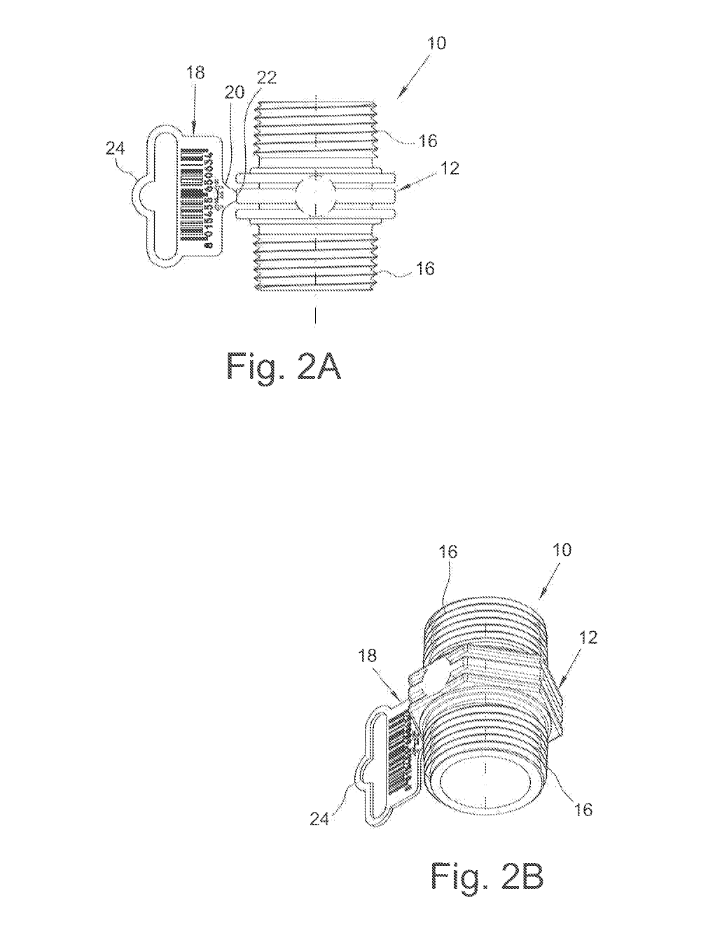

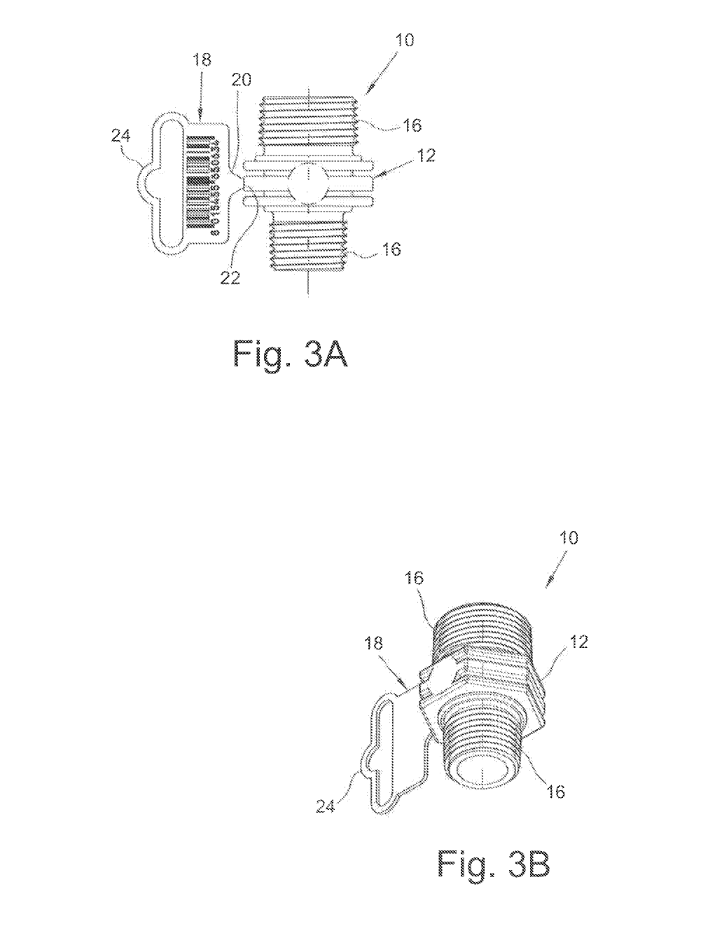

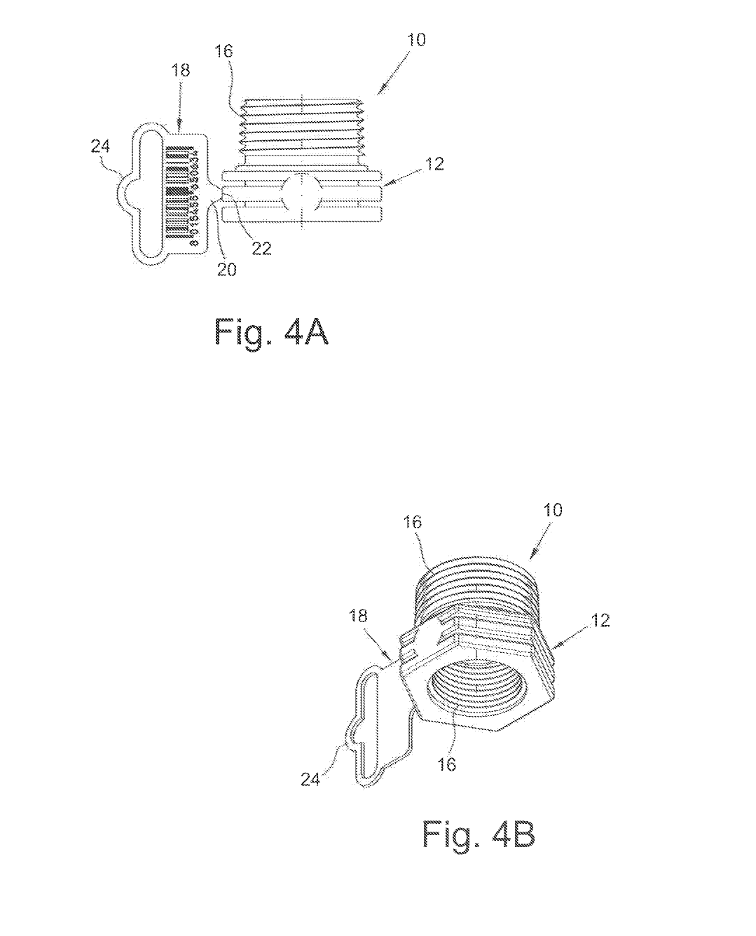

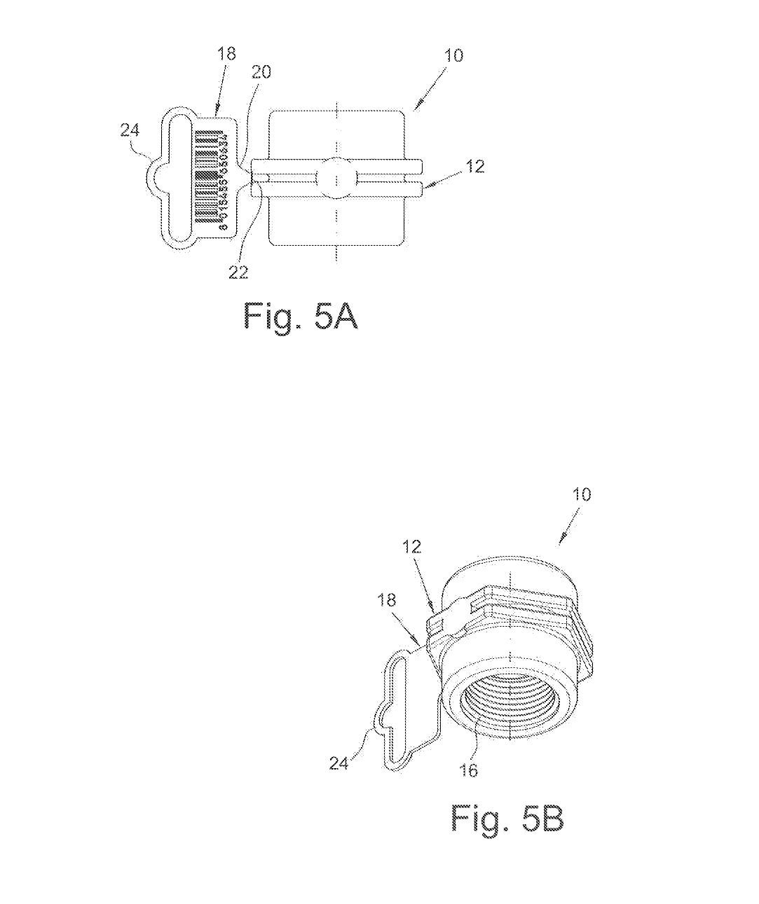

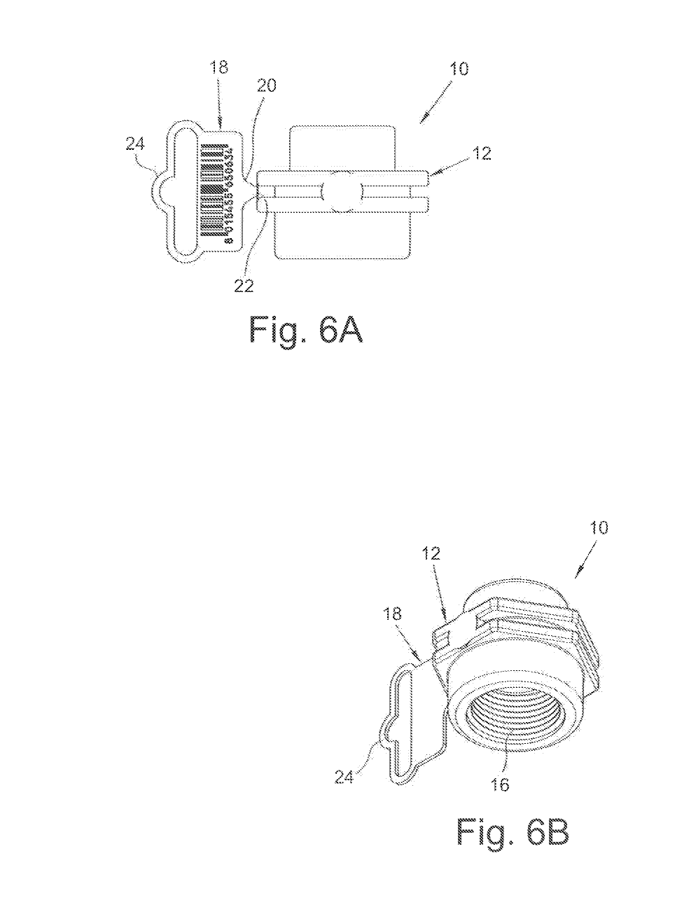

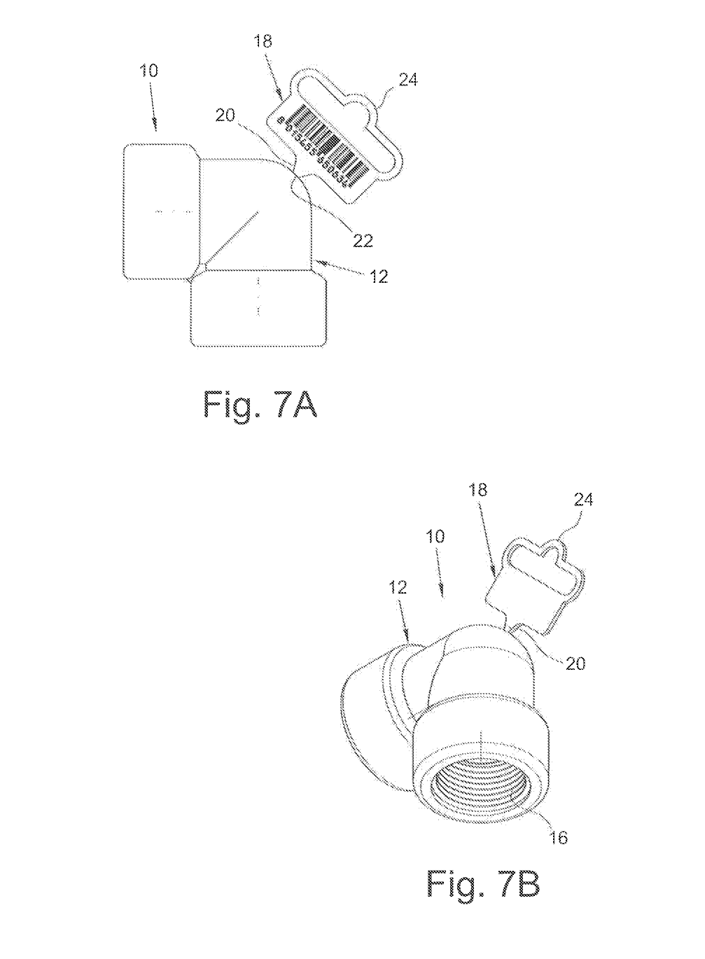

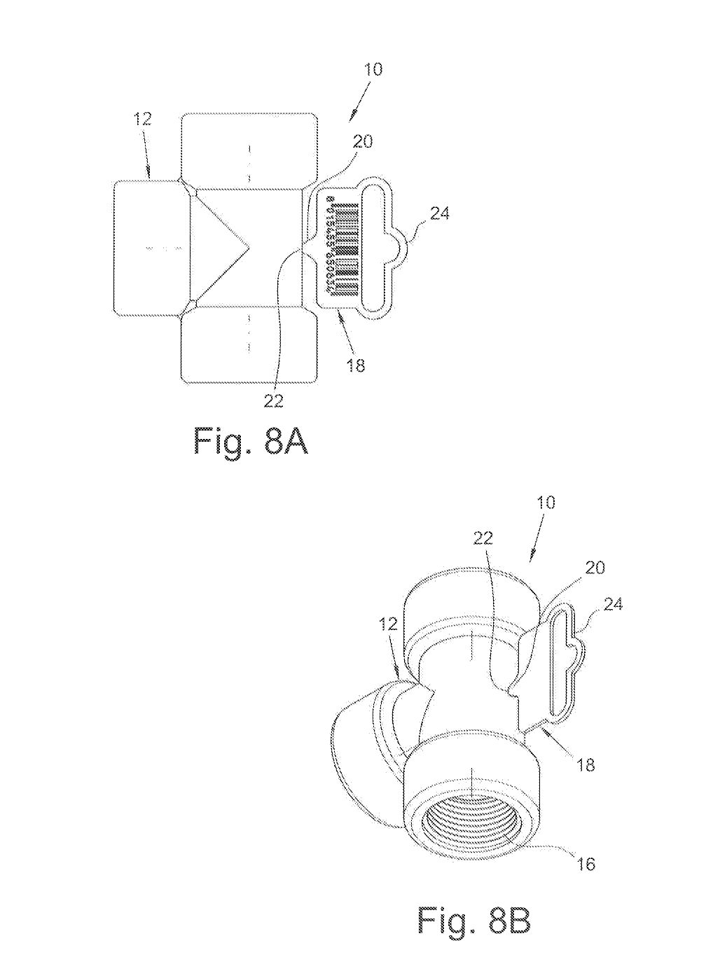

The junction device is substantially made up of an internally hollow main body, manufactured with a plastic material obtained through molding. The main body can be configured so as to define a substantially rectilinear duct inside it, as shown for example in FIGS. 1 to 6, or a curvilinear duct or duct with a complex shape, as shown for example in FIGS. 7 and 8.

On the main body connection means are provided, which make it possible to connect and sealingly fix the junction device to one or more pipelines (not shown) and/or to one or more apparatuses (like for example valves, pumps, taps, etc.) to which such pipelines must be connected. Purely as an example, the connection means can be made in the form of quick coupling means (FIG. 1), or threadings obtained on the outer surface and/or on the inner surface of the main body.

According to the invention, the junction device comprises at least one plate in plastic material, molded in a single piece with the main body. On at least one of the two opposite surfaces of such a plate information relative to the junction device is imprinted, like for example one or more identifier codes or barcodes, a description of the junction device itself, brands and/or logos of any kind.

Preferably, the information relative to the junction device is imprinted on the plate by means of an indirect printing process, so called “pad” or “pad printing”. In detail, a film of indelible ink is transferred from a cliché in steel or in photopolymer, suitably engraved, on the surface of the plate by means of a soft and flexible pad, generally in silicone.

The plate can have a substantially flat development, or be provided with two opposite surfaces with a curvilinear development. The plate can be connected to the main body of the junction device by means of at least one bridge element that is equipped with a breakable weakened portion. In such a way it is possible to separate the plate from the main body of the junction device when the latter is in the operating configuration.

The plate can moreover be provided with one or more slots which allow the junction device to be hung onto the special supporting rods of the display units commonly present in points of sales. In other words, the slot is shaped in a way such as to allow one of the supporting rods of such display units to be inserted inside it.

A junction device of this type has the big advantage of being able to be manufactured in a completely automated manner. The manipulator of the molding press is indeed capable of taking the molded piece and of placing it on a special support where the pad printing machine comes into action.

In addition to this there is the fact that, since the plate has two opposite surfaces available, it is also possible to print, on the surface opposite the one on which the barcode, the logo or the manufacturing or distributor brand of the junction device is imprinted.

It has thus been seen that the junction device for ducts and pipelines according to the present invention achieves the purposes previously highlighted.

The junction device for ducts and pipelines thus conceived can in any case undergo numerous modifications and variants, all covered by the same inventive concept; moreover, all the details can be replaced by technically equivalent elements. In practice the materials used, as well as the shapes and sizes, can be any according to the technical requirements.

The scope of protection of the invention is thus defined by the following claims.

1. A junction device for ducts and pipelines, made up of an internally hollow main body manufactured with a plastic material obtained through molding, the main body being provided with connection means configured for connecting and for sealingly fixing the junction device to one or more pipelines and/or to one or more apparatuses to which said pipelines must be connected, the junction device comprising at least one plate in plastic material, molded in a single piece with the main body, on at least one of the two opposite surfaces of said plate being imprinted information relative to the junction device.

2. A junction device according to claim 1, wherein the information relative to the junction device are imprinted on the plate by means of an indirect printing process, so called “pad” or “pad printing”, wherein a film of indelible ink is transferred from a cliché that is suitably engraved on the surface of the plate by means of a soft and flexible pad.

3. A junction device according to claim 1, wherein the plate has a substantially flat development.

4. A junction device according to claim 1, wherein the plate is provided with two opposite surfaces with a curvilinear development.

5. A junction device according to claim 1, wherein the plate is connected to the main body by means of at least one bridge element equipped with a breakable weakened portion, so that it is possible to separate the plate from the main body when the junction device is in the operating configuration.

6. A junction device according to claim 1, wherein the plate is provided with one or more slots shaped in a way such as to allow the insertion inside them of one of the supporting rods of display units commonly present in points of sales, so that it is possible to hang the junction device onto said supporting rods.

7. A junction device according to claim 1, wherein the connection means are made in the form of quick coupling means.

8. A junction device according to claim 1, wherein the connection means are made in the form of threadings obtained on the outer surface and/or on the inner surface of the main body.

9. A junction device according to claim 1, wherein the main body is configured so as to define a substantially rectilinear duct inside it.

10. A junction device according to claim 1, wherein the main body is configured so as to define a curvilinear duct or duct with a complex shape inside it.

11. A junction device according to claim 1, wherein the information relative to the junction device is made up of one or more identifier codes or barcodes, a description of the junction device, brands and/or logos of any kind.
